(19) United States
(12) Patent Application Publication
(10) Pub. No.: US 2011/0265332 A1
(43) Pub. Date: Nov. 3, 2011

(54) FOLDABLE TETHERED HAND TOOL

(76) Inventors: Daniel Cornell, Los Altos, CA (US); Phillip Joseph Malvini, San Jose, CA (US); Oleh Stecyk, Kerhonkson, NY (US)

(21) Appl. No.: 13/097,929

(22) Filed: Apr. 29, 2011

Related U.S. Application Data
(60) Provisional application No. 61/330,203, filed on Apr. 30, 2010.

(51) Int. Cl. B26B 1/02; B26B 1/10

(52) U.S. Cl. 30/123; 81/489

(57) ABSTRACT

A foldable hand tool is provided with a retractable tether having a fixed end attached to a retractor assembly. The foldable hand tool includes at least one tool pivotally coupled to a handle assembly. The retractor assembly is coupled at the pivot point of the foldable tool. The retractable tether runs in a channel inside the handle assembly to eliminate tether damage from a stowed tool. When the free end of the tether is attached to an anchor point on a support structure or an article of clothing or equipment worn by a user, the retractable tether limits the distance that the foldable hand tool may extend away from the user.

### CROSS-REFERENCE TO RELATED APPLICATIONS

This application claims the benefit of U.S. Provisional Patent Application No. 61/330,203, filed Apr. 30, 2010.

### FIELD OF THE INVENTION

The present invention pertains to the retractable tethering of foldable hand tools and more particularly to the placement of a retraction assembly within a foldable hand tool allowing for the useful tethering of the foldable hand tool to an operator or to some other selected anchor.

### BACKGROUND

A hand tool may be equipped with a tether to prevent the tool from being lost or misplaced or to prevent the tool from causing damage or injury if it is dropped. A tether coupled to a hand tool may be attached to an article of clothing, belt, strap, or band worn by a person using the tool, or the tether may be attached to a support structure such as a scaffold, work bench, part of a vehicle or building, or other secure anchor. Some tethers are equipped with retraction mechanisms to control an amount of slack in a tether or to return a tool connected to a tether to a preferred location. An example of a hand tool with a retraction mechanism is described in U.S. Pat. No. 6,813,976 to Phillip Joseph Malvini and Daniel Cornell, incorporated herein in its entirety.

A tether may have a retraction mechanism at the end of the tether to be attached to a user or a support structure. However, a user utilizing several different tools to accomplish a task may find it inconvenient or uncomfortable to wear a separate tether device for each tool. There may not be sufficient space on a utility belt or sling to attach all of the retraction mechanisms and tethers needed for a selected group of tools. A tether mechanism may jam if an article of clothing or an object in the work area becomes entangled in the mechanism. Additionally, retraction mechanisms for use with a variety of tool or objects may not take into account the size and weight of the tool being used. As such, the force with which a retraction mechanism retracts a tool may be mismatched to the size or weight of the tool being used. Placing a light tool on a tether with a powerful retraction mechanism could cause the tool to be pulled from a user's grasp. Conversely, placing a heavy tool on a tether with a retraction mechanism set for a smaller amount of weight may cause the mechanism to retract slowly or not at all.

Some tethers have a retraction mechanism at the end of the tether attached to a hand tool. Some hand tools equipped with a tether and retraction mechanism have the retraction mechanism attached to a handle on the tool. Such an arrangement has the advantage of providing a good match between the size and weight of a hand tool and the retraction force generated by the retraction mechanism. However, the position of the retraction mechanism on the tool's handle may interfere with a user's grip on the hand tool. Or, the pull exerted by a retraction mechanism on an end of a tool handle may increase the stresses on a user's hand or cause a tool to alter its orientation relative to a work piece, making use of the tool less efficient. For folding hand tools such as knives, saws, wrenches, screwdriver sets, multitools, and so on, care must be taken to avoid entrapping, cutting, abrading, or otherwise damaging a tether when the tool is folded after use.

Hand tools having a retractor mechanism coupled to the tool rather than the user are known in the art. However, the location of the retractor mechanism is often inconvenient and a poorly positioned retractor mechanism may interfere with the ease of use of the hand tool. In addition, the retractor mechanisms known in the art that are incorporated into a hand tool have the disadvantage of increasing the overall dimensions of the hand tool. For example, the length of the hand tool must be increased to allow for the incorporation of the retractor mechanism into the handle of the hand tool or the width of the hand tool much be increased to accommodate the retractor mechanism. Incorporating the retractor mechanism into the handle of the hand tool may also require altering the grip of the tool which may result in an undesirable configuration of the grip for the user.

What is needed is a folding hand tool incorporating a retractable tether and retraction mechanism that is positioned in a location on the hand tool that does not interfere with the dimensions of the tool or the ease of use of the tool.

### SUMMARY

The invention includes a retractor assembly and tether for use with a foldable hand tool in which the retractor assembly is adapted to be incorporated into the hand tool and the tether is coupled to the retractor assembly and has a free end adapted for attachment to a user or stationary object. Embodiments of the invention comprise a retractor assembly and retractable tether positioned at a pivot point of a foldable hand tool. The retractor assembly is effective in storing the retractable tether and removing slack from an extended retractable tether.

In one embodiment, the foldable hand tool includes a handle assembly having a handle pivot point located at a first handle end and at least one tool having a tool pivot point located at a first tool end. A retractor assembly is located at the handle pivot point and the tool pivot point, wherein the retractor assembly pivotally couples the at least one tool at the tool pivot point to the handle assembly at the handle pivot point. A tether is coupled to the retractor assembly at a first end of the tether and may include a coupling device and a line stop at a second end of the tether.

The handle assembly may further include a handle recess to at least partially receive the at least one tool when the at least one tool is rotatably folded towards a second handle end of the handle assembly.

The handle assembly may further include a tether channel to protect and guide the length of the tether within the handle assembly and an aperture through which the tether can exit the handle assembly. Additionally, a tether brake may be included in the handle to control the rate and distance of the retraction and extension of the tether within the handle assembly.

The handle assembly may additionally include a liner lock to secure the tool in the deployed position until a user is ready to release the tool and stow the tool into the handle. This is an important safety feature for tools such as knives and saws.

In an additional embodiment, a pivot member may be used to pivotally mount the tool to the handle assembly and the retractor assembly may then be positioned at the pivot point of the tool and the handle. The pivot member may include a pivot pin and at least one pivot pin retainer. In the case where the pivot member is a pivot pin, the retractor assembly may further comprise a retractor spool positioned around a central rotational axis of the pivot pin.

In another embodiment, the retractor assembly may be included in the handle assembly and positioned at the handle pivot point. In this embodiment, a pivot member located at the handle pivot point and the tool pivot point may be used to pivotally mount the tool to the handle assembly.

A folding hand tool in accordance with an embodiment of the invention includes a tool such as a screwdriver, hex key, knife blade, saw, wrench, nut driver, mechanical or electrical probe, light source, electrical connector, electrical or mechanical measurement instrument, computer data storage device, or other devices adaptable for use in a folding hand tool. Some embodiments of the invention optionally include more than one tool. Some embodiments of the invention include a combination of tools of different sizes and types.

It is known in the art to place a retractor assembly on a tool. However, the position of the retractor assembly on the hand tool in prior art designs may result in a hand tool with an undesirable configuration that hinders the operation of the tool or may require that the dimensions of the hand tool to be increased to accommodate the retractor assembly. With a folding hand tool, the handle must be of sufficient length to accommodate the tool when it is in a stowed position. As such, the incorporation of a retractor assembly as known in the art would require that the length of the handle be increased to accommodate both the retractor assembly and the stowed folding tool. A folding hand tool in accordance the present invention overcomes the prior art disadvantages by incorporating the retractor assembly at, or within, the pivot point of the tool and the handle. This positioning of the retractor assembly does not negatively affect the operation of the folding hand tool. Additionally, the dimensions of the folding hand tool do not need to be increased to accommodate the retractor assembly.

This section summarizes some features of the present invention. These and other features, aspects, and advantages of the embodiments of the invention will become better understood with regard to the following description and upon reference to the following drawings, wherein:

### BRIEF DESCRIPTION OF THE DRAWINGS

FIG. 1 is a front side view of a foldable hand tool in accordance with an embodiment of the invention in which a tool is shown in a deployed position.

FIG. 2 is a front side view of a foldable hand tool in accordance with an embodiment of the invention in which the tool is shown in a stowed position in the handle.

FIG. 3 is a front side view of a foldable hand tool in accordance with an embodiment of the invention illustrating the features of the tether assembly.

FIG. 4 is an interior front side view of a foldable hand tool in accordance with an embodiment of the invention in which a tool is shown in a deployed position.

FIG. 5 is a partial top view of a foldable hand tool in accordance with an embodiment of the invention in which a tool is shown in a deployed position.

FIG. 6 is an interior back side view of a foldable hand tool in accordance with an embodiment of the invention illustrating the features of the tether assembly.

FIG. 7 is an interior front side view of a foldable hand tool in accordance with an embodiment of the invention in which a tool is shown in a stowed position.

FIG. 8 is a front side view of a foldable hand tool in accordance with an embodiment of the present invention in which the tool is a set of hex wrenches.

FIG. 9 is a top view of a foldable hand tool in accordance with an embodiment of the present invention in which the hand tool includes more than one tool.

### DETAILED DESCRIPTION

Embodiments of the invention include a folding hand tool having a tether retraction assembly located at a common pivot point of the handle assembly and a foldable tool, and a tether having a first end attached to the tether retraction assembly and a second end which may be extended by a selected amount from an aperture in the folding hand tool. The tether may include a coupling device. The coupling device provides for removable attachment of the tether to a belt, strap, vest, headgear, or other article worn by a user of the folding hand tool. Alternatively, the coupling device may be attached to a support structure such as a post, pole, scaffold, workbench, toolbox, part of a vehicle or building, or the like. When the tether is attached to a user, the tether prevents the folding hand tool from extending too far away from the user should the user happen to lose their grasp on the handle assembly. The tether assembly also maintains tension in the tether to help avoid forming knots in the tether or entangling the tether with other objects. The handle assembly may include a tether brake which may be used to hold the tether at a selected length or to control the rate at which the tether is retracted into the folding hand tool and wound around the tether retraction assembly.

A folding hand tool as used herein refers to a manually or electrically powered hand tool which has one or more tools rotatably connected to a handle assembly so that the one or more tools may be deployed by rotation of a tool away from the handle assembly or stowed by rotation of a tool toward the handle assembly. A stowed position of a tool may alternatively be a position in a recess partially enclosed within the handle assembly, or with a tool laying alongside and adjacent to the handle assembly. Examples of a folding hand tool include, but are not limited to, a folding pocket knife or jackknife, folding crescent wrenches, hex keys, screwdrivers, nut drivers, and the like, especially sets of such tools connected to a common handle, and multitools comprising different types of tools coupled to a common handle, either for general use or specialized for applications such as golf or fishing. A folding hand tool may also include electrical devices such as, but not limited to, a light source, an electrical probe, an electrical connector, an active electrical or electronic element such as a computer storage device or test circuit, a source of electrical power.

A tether as used herein refers to a flexible line having sufficient strength to support the weight of a folding hand tool and sufficient durability to withstand conditions encountered during normal use of the folding hand tool. Examples of a tether include, but are not limited to, flat, braided, or stranded line made from natural or synthetic materials, metal or plastic chain, stranded or solid wire, and other materials capable of being wound upon a spool.

A retractor assembly as used herein refers to a mechanism having a spool or drum upon which a tether may be wound. A spring in combination with the spool provides a force for tensioning the tether and winding the tether onto the spool. The spool of the retractor assembly rotates about a pivot pin passing through a central rotational axis of the spool. An example of a retractor assembly suitable for use with an embodiment of the invention may be found in U.S. Pat. No. 6,813,976 to Malvini and Cornell. It will be appreciated that many alternative designs for a retractor assembly are adaptable for use with an embodiment of the invention.

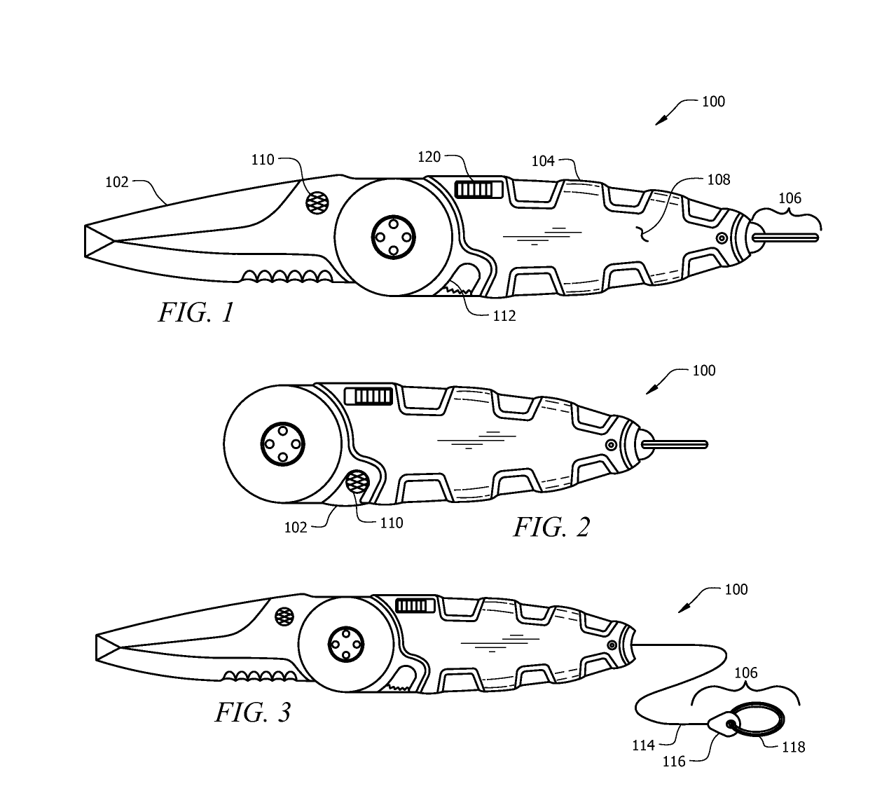

An example of a folding hand tool with a retractable tether in accordance with an embodiment of the invention is shown in a side view in FIG. 1. A folding hand tool 100 has a handle assembly 104 and a tool 102 rotatably coupled to the handle assembly 104. The handle assembly 104 includes one or more removable handle covers 108 for providing a comfortable grip on the folding hand tool 100 and for defining the sides of an interior space inside the handle assembly 104. FIG. 1 illustrates the tool 102 in a deployed position relative to the handle assembly 104. A tether assembly 106 may extend from an end of the handle assembly 104 opposite the end to which the tool 102 is connected. In other embodiments of a handle assembly, the tether assembly 106 exits the handle assembly 104 from other locations than the one shown in FIG. 1.

An optional tether brake 120 may be part of the handle assembly 104. The tether brake 120 may be used to hold the tether assembly 106 at a selected extension length relative to the handle assembly 104. The tether brake 120 may also be optionally used to control a rate at which a tether assembly is retrieved and wound onto a retractor assembly inside the folding hand tool 100. Details of tether brake design and construction are well known in the art and any of several alternative tether brake designs may be adapted for use with an embodiment of the invention.

The tool 102 in the example of FIG. 1 is a knife blade. Many other types of tools may optionally be used in a folding hand tool in accord with an embodiment of the invention. The tool 102 in FIG. 1 may include an optional opening stud 110 attached to the knife blade. The opening stud 110 assists the user in opening the folding hand tool 100 with one hand. When the folding hand tool 100 is folded so that the tool 102 is in a stowed position in a recess of the handle assembly, an optional slot 112 in the handle assembly 104 provides clearance for the opening stud 110. An example of a folding hand tool 100 with a tool 102 and an opening stud 110 in a stowed position in a handle assembly is shown in a side view in FIG. 2.

Parts of a tether assembly 106 are shown in FIG. 3. FIG. 3 shows a free end of a tether assembly 106 comprising a tether 114, a line stop 116 attached to the tether 114, and a coupling device 118 attached to the tether 114. FIG. 3 illustrates a selected length of tether 114 extending from the folding hand tool 100. The line stop 116 prevents the tether 114 from being retracted beyond reach into the folding hand tool 100. A coupling device 118 is provided for removably attaching the tether assembly 106 to a convenient anchor point such as an article of equipment or clothing worn by a user or a separate support structure such as a pole, a fitting on a vehicle or building, and so on. In the example of FIG. 3, the coupling device 118 is a split ring. Other examples of a coupling device 118 suitable for use with an embodiment of the invention include, but are not limited to, a clip, a clamp, a hook, a strap with buttons, snaps, buckles, or some other closure, hook-and-loop fasteners, a karabiner, and so on.

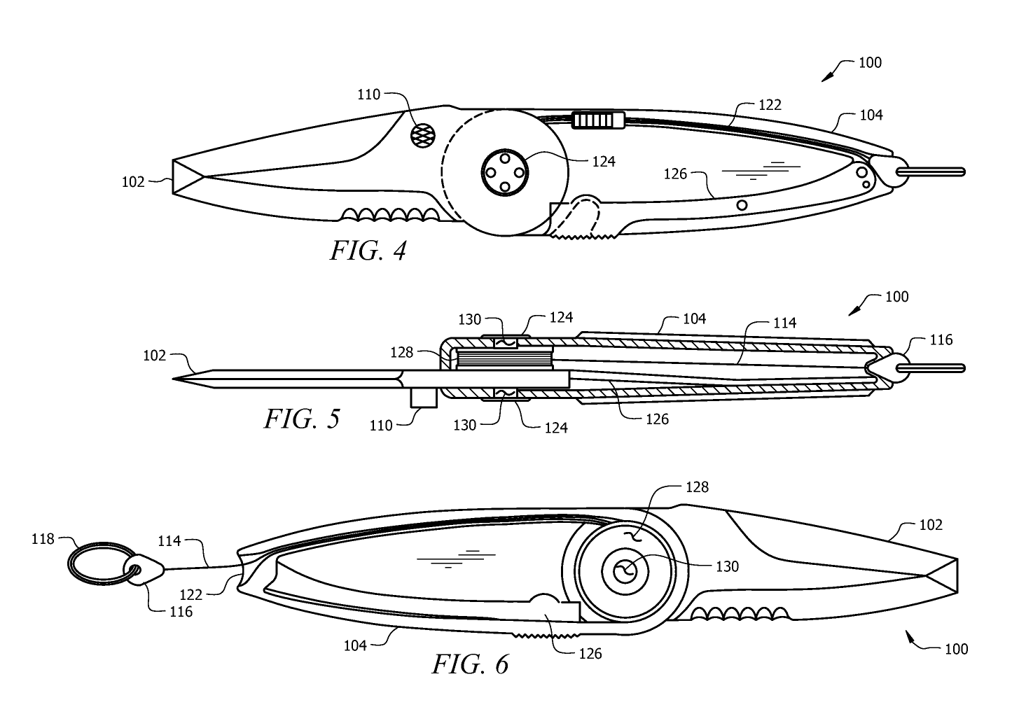

Examples of internal parts of a folding hand tool 100 are shown in the partial side view of FIG. 4. FIG. 4 shows the folding hand tool 100 of FIGS. 1-3, with a handle cover removed to expose a space inside the handle assembly 104. The tool 102 is rotatably connected to the handle assembly 104 by a hinge comprising a pivot pin. One or more pivot pin retainers 124 engage with a pivot pin passing through apertures in the handle assembly 104 and tool 102. The pivot pin retainers may optionally be threaded for removable attachment to a pivot pin or may alternately be formed as part of a pivot pin. The pivot pin retainers 124 and pivot pin form a hinge about which the tool 102 and handle assembly 104 may be rotated. In FIG. 4, a pivot pin is underneath the pivot pin retainer 124 and so is not visible in this view. A better view of a pivot pin appears in FIGS. 5 and 6.

Continuing with FIG. 4, a liner lock 126 is positioned in a space formed in the handle assembly 104 formed between the handle covers. The liner lock engages with the tool 102 to hold the tool in its deployed position. When the tool 102 is placed in its stowed position inside, or alternately partially inside, a recess of the handle assembly 104, the tool is positioned in the space between the handle covers. A tether channel 122 formed in the handle assembly 104 provides a protected path for the tether inside the folding hand tool 100. The channel 122 prevents the tether from being damaged by cutting, abrasion, or crushing by the tool when the tool is stowed. A shape of the channel may be arranged to provide a location and a braking surface for an optional tether brake. In alternative embodiments, a tool may be stowed adjacent to and outside the handle assembly 104.

The partial assembly illustrated in the side view of FIG. 4 is shown in a partial top view in FIG. 5. In FIG. 5, the position of a retractor assembly 128 is shown relative to a hinge comprising two pivot pin retainers 124 coupled to opposite ends of a pivot pin 130. The pivot pin 130 passes through a central rotational axis of the retractor assembly 128 so that a spool of the retractor assembly 128 rotates around the pivot pin 130 when the tether 114 is either pulled from or retrieved by the retractor assembly 128. The retractor assembly 128 may optionally be in direct contact with the tool 102 or may optionally be separated from the tool 102, or from the handle assembly 104, by a spacer. A line stop 116 is shown in position to prevent the tether 114 from being fully withdrawn into the tether channel inside the handle assembly 104. A liner lock 126 may optionally be provided to hold a tool 102 in a deployed position. The liner lock 126 may be manually released to allow the tool 102 to be stowed inside a recess in the handle assembly 104.

FIG. 6 shows a side view of the exemplary folding hand tool 100 from FIGS. 4 and 5. FIG. 6 shows a side of the folding hand tool opposite the side shown in FIG. 4. In FIG. 6, the retractor assembly 128 may be more clearly seen as rotating about a pivot pin 130. The tether assembly comprising a coupling device 118 and line stop 116 at the free end of the tether 114 is seen to pass through a tether channel 122 in the handle assembly 104. The fixed end of the tether 114 is attached to the retractor assembly 128. The handle assembly 104 and tool 102 are rotatably coupled to each other by the pivot pin 130 of the retractor assembly 128.

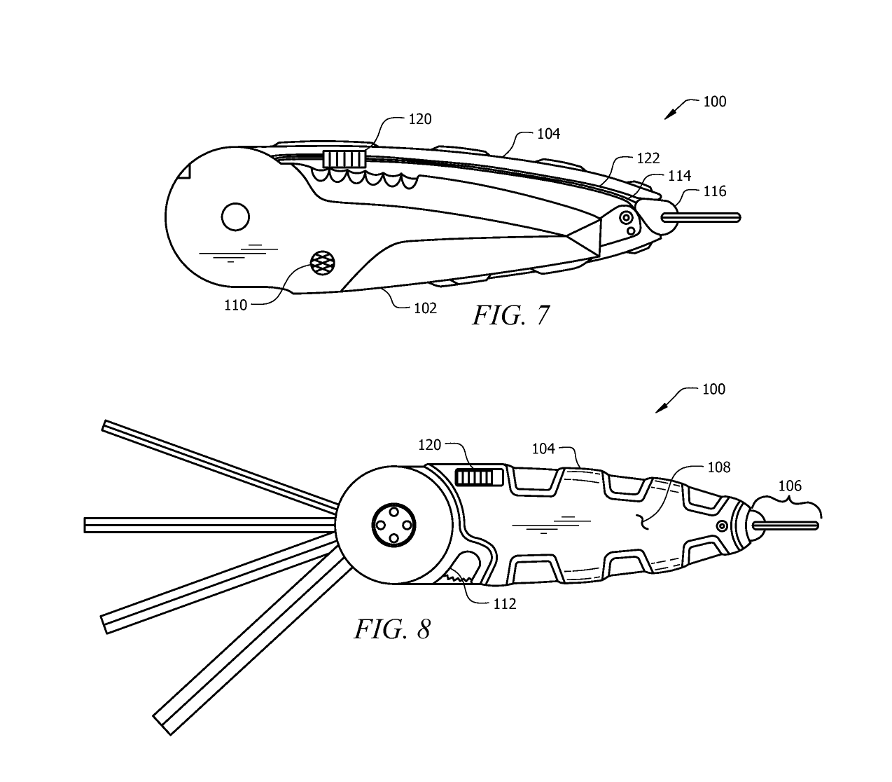

FIG. 7 illustrates the folding hand tool 100 of FIGS. 4-6 with a tool 102 in a stowed position in the handle assembly 104. The tether channel 122 visible in FIG. 7 prevents the tool 102 from contacting the tether 114 when the tool is stowed in the handle assembly. An example of a position for a tether brake 120 is shown along the tether channel 122, and the line stop 116 is shown in position to prevent the tether 114 from being retracted beyond reach into the channel 122.

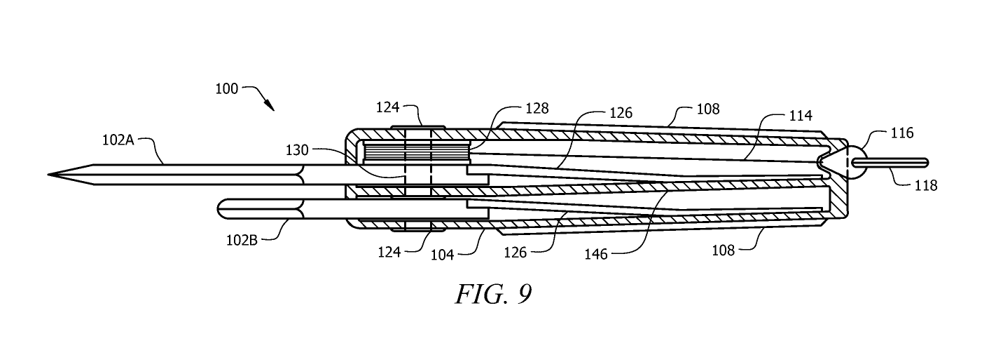

FIG. 9 illustrates the folding hand tool 100 in which the tool is a set of hex wrenches. The tether channel 122 visible in FIG. 8 prevents the tool 102 from contacting the tether 114 when the tool is stowed in the handle assembly. An example of a position for a tether brake 120 is shown along the tether channel 122, and the line stop 116 is shown in position to prevent the tether 114 from being retracted beyond reach into the tether channel 122. It will be appreciated that embodiments of the invention may optionally include many variations to the example of FIG. 8 wherein the tool may be a screwdriver, hex key, knife blade, saw, wrench, nut driver, mechanical or electrical probe, light source, electrical connector, electrical or mechanical measurement instrument, computer data storage device, or other devices adaptable for use in a folding hand tool.

Some embodiments of a folding hand tool in accordance with an embodiment of the invention include more than one tool. An example of a folding hand tool 100 having more than one tool is shown in the partial top view of FIG. 9. In FIG. 9, a handle assembly 104 comprises one or more handle covers 108 attached to sides of the handle assembly. A pivot pin 130 is held in the handle assembly 104 by one or more pivot pin retainers 124. The pivot pin 130 and pivot pin retainers 124 form a hinge for rotatably connecting a first tool 102A and a second tool 102B to the handle assembly 104. A retractor assembly 128 is positioned on the pivot pin 130 so that the retractor assembly 128 rotates about the pivot pin 130 when the tether 114 is withdrawn from the retractor assembly 128 or retrieved onto the retractor assembly. A separate liner lock 126 may optionally be provided for each tool (102A, 102B). An optional spacer 146 may be provided to provide clearance for deployment and storage of adjacent tools.

It will be appreciated that embodiments of the invention may optionally include many variations to the example of FIG. 9. For example, the folding hand tool 100 of FIG. 9 may easily be expanded to include more than two tools. A second pivot pin may optionally be included in the handle assembly at the end nearest the line stop 116 and coupling device 118 so that tools may be unfolded from both ends of the folding hand tool. And, although FIG. 9 shows a retractor spool assembly 128 to one side of a stack of tools (102A, 102B), a retractor spool assembly 128 may optionally be positioned at any selected position within the stack of tools so as to separate two adjacent tools. A second retractor spool assembly may optionally be included so that a folding hand tool may always be connected by a retractable tether to at least one anchor point while the folding hand tool is being transferred from one work location to another. These optional variations are considered to be within the scope and spirit of the embodiments of the invention disclosed herein.

Unless expressly stated otherwise herein, ordinary terms have their corresponding ordinary meanings within the respective contexts of their presentations, and ordinary terms of art have their corresponding regular meanings.

What is claimed is:

1. A hand tool comprising:
a handle assembly having a handle pivot point located at a first handle end;
at least one tool having a tool pivot point located at a first tool end;
a retractor assembly located at the handle pivot point and the tool pivot point, the retractor assembly to pivotally couple the at least one tool at the tool pivot point to the handle assembly at the handle pivot point; and
a tether coupled to the retractor assembly at a first tether end.

2. The hand tool of claim 1, wherein the handle assembly further comprises a handle recess to at least partially receive the at least one tool when the at least one tool is rotatably folded towards a second handle end of the handle assembly.

3. The hand tool of claim 1, wherein the handle assembly further comprises a tether channel.

4. The hand tool of claim 1, wherein the handle assembly further comprises a tether brake.

5. The hand tool of claim 1, wherein the handle assembly further comprises an aperture located at a second handle end of the handle assembly, a second tether end of the tether to extend through the aperture.

6. The hand tool of claim 1, further comprising a liner lock positioned in a space formed in the handle assembly.

7. The hand tool of claim 1, wherein the tether further comprises a coupling device positioned at a second tether end.

8. The hand tool of claim 1, wherein the tether further comprises a line stop positioned at a second tether end.

9. The hand tool of claim 1, further comprising a pivot pin positioned at a central rotational axis of the retractor assembly, the pivot pin to pivotally couple the at least one tool to the handle assembly.

10. The hand tool of claim 1, wherein the at least one tool is a knife.

11. A hand tool comprising:
a handle assembly having a handle pivot point located at a first handle end;
at least one tool having a tool pivot point located at a first tool end;
a pivot member located at the first handle end, the pivot member to pivotally mount the at least one tool at the tool pivot point to the handle assembly at the handle pivot point;
a retractor assembly positioned at the handle pivot point and the tool pivot point; and
a tether coupled to the retractor assembly at a first tether end.

12. The hand tool of claim 11, wherein the handle assembly further comprises a tether channel.

13. The hand tool of claim 11, wherein the handle assembly further comprises a tether brake.

14. The hand tool of claim 11, wherein the pivot member further comprises a pivot pin and at least one pivot pin retainer.

15. The hand tool of claim 11, wherein the retractor assembly further comprises a retractor spool positioned around a central rotational axis of the pivot member.

16. A hand tool comprising:
a handle assembly having a handle pivot point located at a first handle end, the handle assembly comprising a retractor assembly positioned at the handle pivot point;
at least one tool having a tool pivot point located at a first tool end;
a pivot member located at the first handle end, the pivot member to pivotally mount the at least one tool at the tool pivot point to the handle assembly at the handle pivot point; and
a tether coupled to the retractor assembly at a first tether end.

17. The hand tool of claim 16, wherein the handle assembly further comprises a tether channel.

18. The hand tool of claim 16, wherein the handle assembly further comprises a tether brake.

19. The hand tool of claim 16, wherein the pivot member further comprises a pivot pin and at least one pivot pin retainer.

20. The hand tool of claim 12, wherein the retractor assembly further comprises a retractor spool positioned around a central rotational axis of the pivot member.
